(19) United States
(12) Patent Application Publication
(10) Pub. No.: US 2005/0258976 A1
(43) Pub. Date: Nov. 24, 2005

(54) Household digital automation control system

(76) Inventor: Yin-Shang Zteng, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/849,261

(22) Filed: May 20, 2004

(51) Int. Cl. H04Q 1/00; H04B 10/00

(52) U.S. Cl. 340/825.72; 398/106

(57) ABSTRACT

The present invention provides a digital household automation control system, which utilizes a relay transmitter processing the RF signal emitted out from an actuating input apparatus in converting treatment into an infrared-ray signal, then emit the infrared-ray signal to the proper matching electric appliance and controller to carry out control function, so in the daily life, just need to operate on a single actuating input apparatus can control all the electric appliances; of course, operating on the actuating input apparatus can directly or indirectly adjust and switch the controller via the relay transmitter for increasing the convenience in the daily life.

### BACKGROUND OF THE INVENTION

1. Field of the Invention

The present invention relates to monitored control system, and more especially to a household digital automation control system that by an actuating input apparatus all electrical appliances in the house are integrated and controlled even overrun their original control ranges.

2. Description of the Related Art

Along with the time progress, the various electrical appliances are increasing in people's daily life, such like TV, air conditioner, hi-fi equipment, and so on, even developed to remote on-off control lamps or power, all these electric appliances may be matched with a remote control respectively for controlling them by operating on the remote control, in which the principle is that the remote control emits infrared ray signal to the infrared receiver set upon the electric appliance so as to control the action of the electric appliance.

But, in this way-emitting and receiving infrared ray, the user has to hold the remote control to aim to the controlled electric appliance exactly, meanwhile has to keep in a certain range, so that if the user goes out a little bit of the limited control range, he can not control the electric appliance any more, so it puts the user to inconvenience.

Therefore, a household automation control system was provided by some manufactures, as shown in FIG. 1, which is comprised of a transmissive infrared-ray remote control 80, several transmitters 81 placed in different rooms 90 90′, a control center 82, a receiver 83 connected with said transmitter 81, and a relay transmitter 85 receiving the signal from said control center 82 further to remote-control the electric appliances 84 (like TV and so on); by sending out an infrared ray signal aiming to the receiver 83 from the remote control 80, thereby to make the transmitter 81 emit a RF (radio frequency) signal to the control center 82, therein the RF signal is transferred to the relay transmitter 85 finally to emit an infrared-ray signal to control the electric appliance 84 on-off in the room 90′ locating the control center 82.

But, in practice, a fact is found that the infrared-ray signal emitted from the remote control 80 has to directly shoot on the receiver 83 without any block, so that the receiver 83 can receive the infrared-ray signal further to control next chain, in a word, when the remote control 80 is not in a same room with the receiver 83, all the control operation is not able to carry out, so it will bring up some inconvenience, hence in this case, just depending on the number of rooms, to allocate coordinating number sets of transmitter 81, control center 82, receiver 82 and relay transmitter 85, therefore the equipment cost is gone up, so it is not a perfect resolution.

### SUMMARY OF THE INVENTION

Therefore, the object of the present invention is to provide a digital household automation control system that integrates multiple actuating input apparatuses for control operation.

For achieving the object mentioned above, the digital household automation control system of the present invention utilizes a relay transmitter processing the RF signal emitted out from an actuating input apparatus in converting treatment into an infrared-ray signal, then emit the infrared-ray signal to the proper matching electric appliance and controller to carry out control function, because the RF signal is more powerful in intensity and penetrability than infrared-ray signal, the receiving effect is not affected by some facts such like surrounding environment or limited receiving range and so on, meanwhile it converses to the infrared-ray signal more efficiently and accurately to control the electric appliances and controller action, in addition, the relay transmitter integrates all of the infrared-ray signals of the electric appliances and controllers at inside, so in the daily life, just need to operate on a single actuating input apparatus can control all the electric appliances; of course, operating on the actuating input apparatus can directly or indirectly adjust and switch the controller via the relay transmitter for increasing the convenience in the daily life.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 is a block-diagram of the prior art.

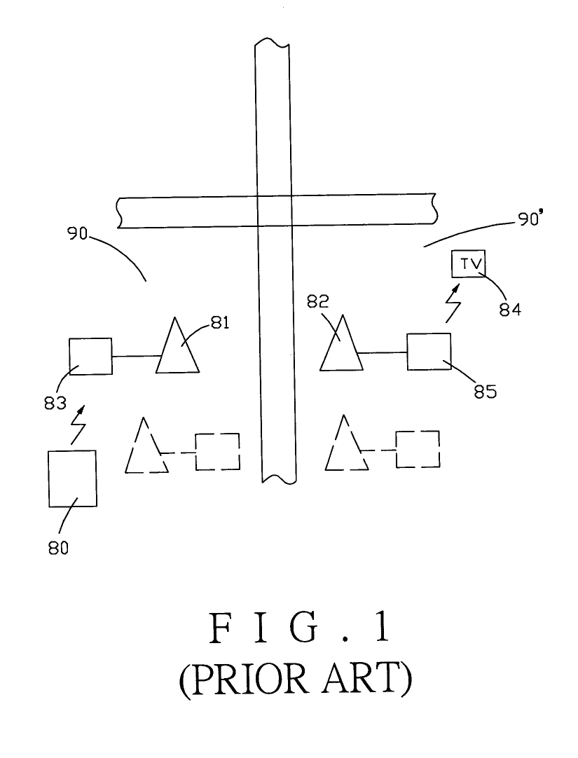

FIG. 2 is a block-diagram showing the first embodiment of the present invention.

FIG. 3 is a diagram showing the connection of the controller of the first embodiment of the present invention.

FIG. 4 is a block-diagram showing the second embodiment of the present invention.

FIG. 5 is a block-diagram showing the third embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

Before describing the preferred embodiments of the present invention, note that similar components mentioned in following are given a same symbol number.

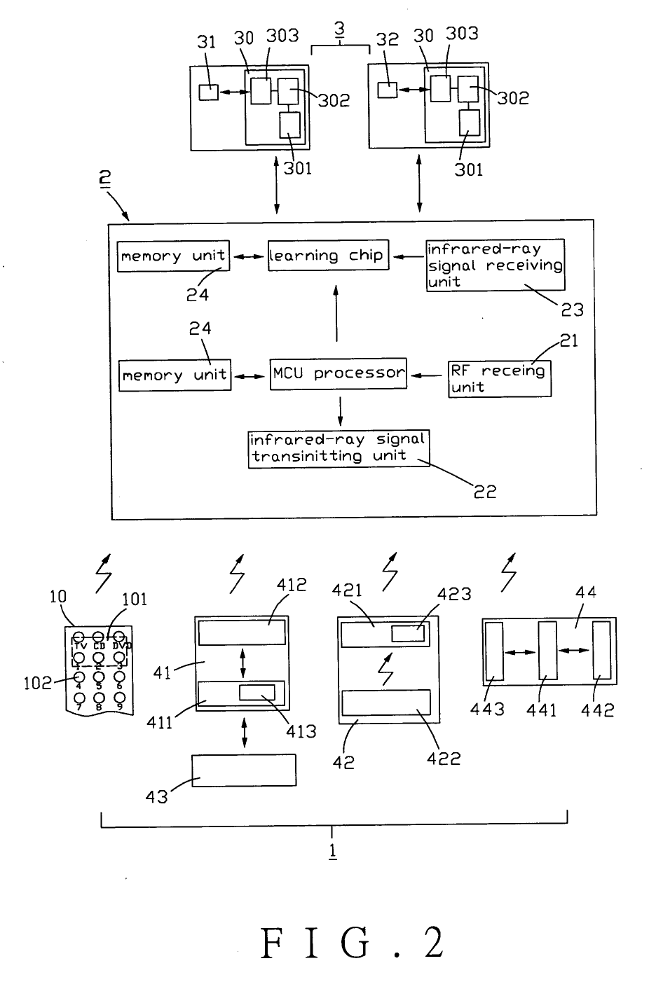

Referring to FIG. 2, the present invention provides the first preferred embodiment of a digital household automation control system, which includes an actuating input apparatus 1, a relay transmitter 2 and several controllers 30; wherein, the actuating input apparatus 1 is a remote control 10 in this embodiment, the remote control 10 includes a RF transmitting unit 101 emitting RF signal in proper time, and proper number of numeric keys 102, in which each one is pre-configured into controlling an electric appliance (not shown in drawings, such like TV, air conditioner, hi-fi equipment and so on) or a controller 30 (such like lamp controller 31, and power controller 32 and so on), depending on the necessary of the user, when pressing down each key 102 symbolized as a electric appliance or a controller 30, the remote control 10 will emit a coordinating RF signal to the controlled electric appliance or controller 30, certainly the remote control 10 can be pre-set a certain number and sequence of controlled electric appliance or controllers 30 and encoded in an addressing mode into one key for group control by emitting a cluster RF signals at one time to control a group of electric appliances or controllers 30 respectively and synchronously, thereby not only increase the quality of controlled electric appliances or controllers 30, but also avoid conflicting and interfering with neighbors as using.

Particularly, besides above-mentioned input apparatus 1 can be a remote control 10, in the second preferred embodiment it can be a system consisted of computer 41, mobile communication unit 42, network adapter 43 and detecting actuator 44, wherein, the computer 41 has a host 411 connecting with some ambient equipments 412, and a RF transmitter 413 emitting RF signal in the proper time set upon the host 411; said ambient equipments 412 includes like wireless mouse and keyboard and so on (not shown in drawings), by working on the ambient equipments 412, so as to control the RF transmitter 413 emits RF signal; certainly the user also can operate the system through a computer connected with the network adapter 43 to remotely control the RF transmitter 413 via the network (like ADSL) emitting a RF signal to the relay transmitter 2, further to control various electric appliances action and controller 30 switching, or pre-encode addresses and pre-set timer and so on in the computer, so that the computer can carry out the pre-set functions by itself automatically.

The mobile communication unit 42 includes a host 421, and a cell phone 422 connecting to the host 421 via the radiophone network, in which the host 421 has a RF transmitter 423 built on for emitting RF signal in proper time, thereby the user can send a pre-set short message from the mobile phone to the host 421, further to remotely control the relay transmitter 2 to control the various electric appliances and controllers 30.

The detecting actuator 44 is comprised of a detecting unit 442 triggered by the signal of detecting and receiving any environment change, a central processing unit 441 processing the signals came from the detecting unit 442, and a transmitting unit 443 emitting the signals coming from the central processing unit 441, wherein, the detecting unit 442, not only connects to the security system (which is not the feathers of the present invention, so it is not described here), but also connects to temperature sensors, magnetic induction controller and so on for detecting the any change of the environment in temperature and open any doors or windows and sending the signals back; the abnormal situation is transferred to the user via the mobile communication unit 42 or the network adapter 43 to form bilateral communication, and it also can be connected to an infrared-ray sensor for detecting any infrared-ray source, so that once if said detecting actuator 44 is triggered by the detected infrared signal, the transmitting unit 443 will cut in an electric appliance or controller 3, or a group electric appliances and controllers 30 pre-coded in addressing model.

Additionally, the relay transmitter 2 includes a RF signal receiving unit 21 and an infrared-ray signal transmitting unit 22; wherein, the RF receiving unit 21 can receive the RF signal emitted from the remote control 1, and transfer the RF signal into another one sent to the infrared-ray signal transmitting unit 22 to make it emit an infrared-ray signal to control the various electric appliances or controllers 30; in another case, the relay transmitter 2 includes an infrared-ray signal receiving unit 23, and a memory unit 24 connecting with the receiving unit 23, said infrared-ray signal receiving unit 23 can receive and learn all the remote controlling signals of the electric appliances and controllers 30 controlled by the relay actuator 2, and save them into the memory unit 24.

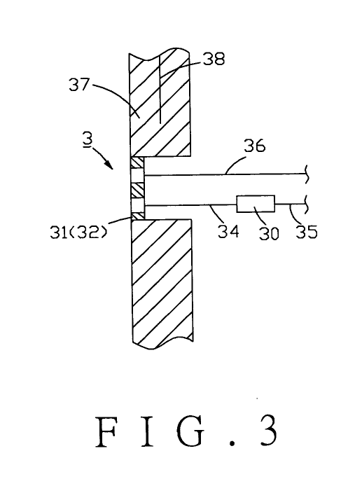

Cooperating to referred FIG. 3, the controllers 3 used in household in common are divided into lamp controller 31 and power controller 32 two sorts, whatever the lamp controller 31 or the power controller 32, it always connects with the fire line 36 of the power source and the load line 34 with the both ends respectively, just like replacing the conventional switcher on the wall without any extra process needed to be done; in the other hand, each controller 30 is comprised of a receiving unit 301, a central processing unit 302 and a controlling unit 303, wherein, the receiving unit 301 can receive the infrared-ray signal from the relay transmitter 2, and send the signal to the central processing unit 302, therein comparing, analyzing treatment, then to drive the controlling unit 303 to control the lamp controller. 31 or power controller 32 and so on actions.

Referring to FIG. 2 and FIG. 3, as using the embodiment of the present invention, the user can directly press down the key 102 of the remote control 1, in which the key 102 has pre-set and saved with the coded address of coordinating electric appliance and controller 30, meanwhile it also can be pre-set a certain number and sequence of controlled electric appliance or controllers 30 and encoded in an addressing mode, so as to press down each key 102 to emit a coordinated RF signal to the RF receiving unit 21 of the relay transmitter 2, and efficiently avoid conflicting and interfering with neighbors as using, and the RF signal is transferred into another one sent to the infrared-ray signal transmitting unit 22 to make it emit an infrared-ray signal to the various electric appliances or controllers 30 to control them cut in or off; especially to said controllers 30, depending on the different sort of the lamp controller 31 or power controller 32 set in the household, may be some different in structure, taking the lamp controller 31 as an example, it is connected with a fire line 36 and a load line 34 with the both ends, besides cutting in or off, also increases an illumination adjustor for controlling the light intensity as using; to the power controller 32, it is directly controlled to cut in or off by the controller 30.

Following above-description, by means of the RF signal with more powerful in intensity and penetrability than infrared-ray signal, when pressing down the key 102 to emit RF signal, whatever the user stands in or out the range of the infrared-ray control, the RF signal will be transferred into an efficacy and accuracy infrared-ray signal to control the electric appliances or controllers 30, meanwhile avoid range and environment limiting and affecting the transmission of the control signal, in addition, the relay actuator 2 can be controlled respectively by the computer 41, the mobile communication unit 42, the network adapter 43 or the detecting actuator 44, so wherever the user stays, and whatever he selects to operate on computer 41, or personal mobile or network IP communication apparatus, to directly control or actuate pre-coded addressing model or timing model remotely to trigger the input apparatus 1 to emit a RF signal, further to control the relay transmitter 2 to transfer the RF signal into an infrared-ray signal given out, thereby control the electric appliances and the controllers 30 action.

Following above-description, in the preferred embodiment of the present invention, if want to increase some the electric appliances and controllers 30, just need to send the infrared-ray signals of their original matched remote controls (not shown in drawings) out for receiving by the receiving unit 23 of the relay transmitter 2, in which the relay transmitter 2 can save the new infrared-ray signals into the memory unit 24 for facilitating to the user controlling the increased electric appliances and controllers 30 afterward as well as operating in the above-mentioned way; because the memory unit 24 of the relay transmitter 2 has saved many infrared-ray signals of various electric appliances and controllers, so the remote control 1 of the preferred embodiment has one-to-one control or simultaneous control a group of various electric appliances or controllers 30 functions, for this just need to operate on the input apparatus 1, if increase the assistance of linking the communication and network, the life will become more convenient.

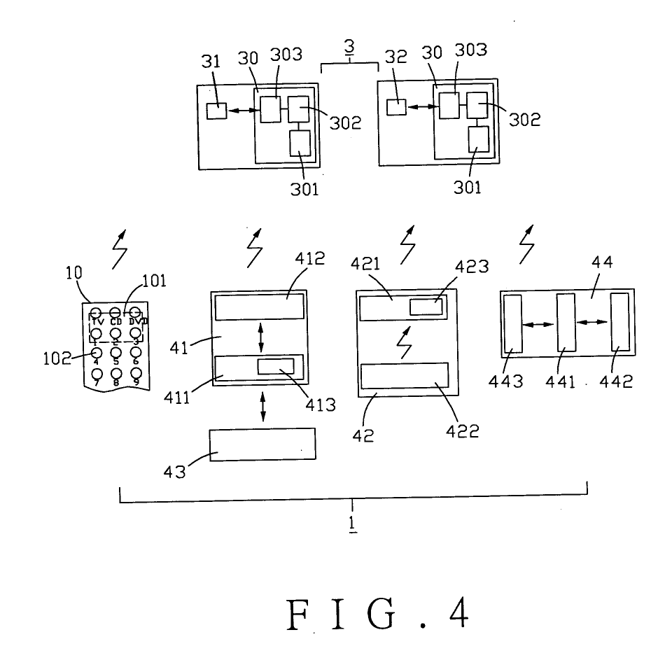

Referring to FIG. 4, the second preferred embodiment of the present invention is shown, in the digital household automation control system, the RF signal emitted from the input apparatus 1 not only can be received by the receiving unit 21 of the relay transmitter 21, but also can be received by a receiving unit 301 attached in the controller 30 directly without transferring via the relay transmitter 2, then send the signal to the central processing unit 302, therein comparing, analyzing treatment, then to drive the controlling unit 303 to control the lamp controller 31 or power controller 32 and so on to adjust the light intensity or cut in-off to get the functions as described in the first embodiment.

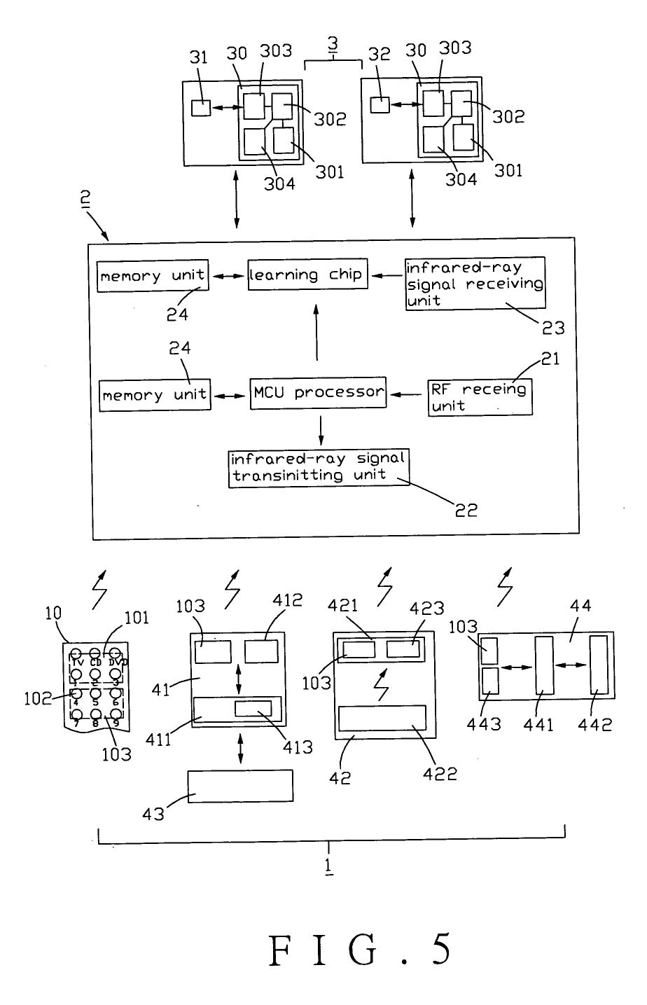

Referring to FIG. 5, it shows the third preferred embodiment of the present invention, wherein, the input apparatus 1 is attached with a RF receiving unit 103, and the controller 30 is built upon with a RF signal transmitting unit 304, so when operating on the input apparatus 1 to directly or indirectly control the relay transmitter 2, the user can get some feedback message from the controllers 30 after they are controlled to carry out adjusting or cutting in-off by the RF signal process via the RF transmitting unit 304, so as to know the working status of the controllers 30. According to the above description, and comparing with the conventional products, the present invention has some advantages as follows:
1. The present invention, in which a relay transmitter receiving a RF signal from a remote control, or circum-connected apparatuses and transferring it into an infrared-ray signal and transmitting to the coordinated electric appliance or controller to control them action, takes the advantage of the RF signal with more powerful in intensity and penetrability than infrared-ray signal for avoiding affecting from the environment or the limited receiving range, so that the transferred infrared-ray signal performances more efficaciously and accurately to control the electric appliances and controllers, meanwhile integrate all the infrared-ray signals of controlled electric appliances into the relay transmitter for facilitating to the user operating on input apparatus beside hand to send out a RF signal, further to control a matched or a group encoded electric appliances and controllers cutting in-off or adjusting for carrying out fully monitoring and controlling them in the daily life.
2 directly connected with a fire line and a load line just replacing the conventional switcher without re-hidden in the wall, so as to facilitate and simplifying mounting process, and increase adjusting light intensity function.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A digital household automation control system, the family has electric appliances and controllers; meanwhile the controller is connected with a fire line of power and a load line with the both ends, wherein said digital household automation control system is comprised of: an input apparatus attached with a transmitting unit emitting RF signal in proper time; a relay transmitter including a RF receiving unit and an infrared-ray signal transmitting unit, wherein, the RF receiving unit can receive the RF signal emitted from the remote control, and transfer the RF signal into another one sent to the infrared-ray signal transmitting unit to make it emit an infrared-ray signal to control the various electric appliances or controllers; a controller cross-connected on a fire line of power and a load line, which includes a receiving unit, a central processing unit and a controlling unit controlled by the central processing unit, wherein, the receiving unit can receive the RF signal from the input apparatus directly, and send the signal to the central processing unit, therein comparing, analyzing treatment, then to drive the controlling unit to control the controller actions.

2. A digital household automation control system as claimed in claim 1, wherein said relay transmitter also includes an infrared-ray receiving unit and a memory unit connected with the infrared-ray receiving unit, so that the infrared-ray receiving unit can receive the new infrared-ray signals from the remote controls of increased electric appliances, and save them into the memory unit.

3. A digital household automation control system as claimed in claim 1, wherein said input apparatus can be a remote control.

4. A digital household automation control system as claimed in claim 1, wherein said input apparatus can be a computer.

5. A digital household automation control system as claimed in claim 4, wherein said computer is linked into a network adapter so as to control the relay transmitter working via the network.

6. A digital household automation control system as claimed in claim 1, wherein said input apparatus can be a mobile communication unit, thereby controlling the relay transmitter working.

7. A digital household automation control system as claimed in claim 1, wherein said input apparatus can be a detecting actuator, which can is comprised of a detecting unit triggered by a signal of detecting and receiving any environment change, a central processing unit processing the signals came from the detecting unit, and a transmitting unit emitting the signals coming from the central processing unit to control the relay transmitter action.

8. A digital household automation control system as claimed in claim 1, wherein said input apparatus is attached with a RF receiving unit, and the controller is built upon with a RF signal transmitting unit, so that the controller can send a feedback message to the RF receiving unit of the input apparatus after carrying out adjusting or cutting in-off under the controlling of the RF signal, in order to let the user know the working status of the controllers.
